(19) United States
(12) Patent Application Publication
(10) Pub. No.: US 2009/0119667 A1
(43) Pub. Date: May 7, 2009

(54) METHOD AND APPARATUS FOR IMPLEMENTING TRANSACTION MEMORY

(76) Inventors: Rui Hou, Beijing (CN); Xiaowei Shen, Hopewell Junction, NY (US); Hua Yong Wang, Beijing (CN)

Correspondence Address: IBM CORPORATION, T.J. WATSON RESEARCH CENTER, P.O. BOX 218, YORKTOWN HEIGHTS, NY, 10598, US

(21) Appl. No.: 12/265,788

(22) Filed: Nov. 6, 2008

(30) Foreign Application Priority Data
Nov. 7, 2007 (CN) 200710169244.2

(51) Int. Cl. G06F 9/46; G06F 12/00

(52) U.S. Cl. 718/101; 711/154; 711/E12.001

(57) ABSTRACT

A method and apparatus for implementing transactional memory (TM). The method includes: allocating a hardware-based transaction footprint recorder to the transaction, for recording footprints of the transaction when a transaction is begun; determining that the transaction is to be switched out; and switching out the transaction, where the footprints of the switched-out transaction are still kept in the hardware-based transaction footprint recorder. According to the present invention, transaction switching is supported by TM, and the cost of conflict detection between an active transaction and a switched-out transaction is greatly reduced since the footprints of the switched-out transaction are still kept in the hardware-based transaction footprint recorder.

### CROSS-REFERENCE TO RELATED APPLICATIONS

This application claims priority under 35 U.S.C. §119 from Chinese Patent Application No. 200710169244.2 filed on Nov. 7, 2007, the entire contents of which are incorporated herein by reference.

### BACKGROUND OF THE INVENTION

1. Field of the Invention

The present invention relates to the field of computer technology, and more particularly, relates to a method and apparatus for implementing transactional memory (TM). The TM allows applications, programs, modules, etc. to access a shared memory in an atomic and isolated manner.

2. Description of Related Art

The use of TM permits different threads to be executed simultaneously so that an extremely high processing efficiency can be acquired.

To reference the implementation of TM and some terms and concepts, we refer to Document 1, Maurice Herlihy and J. Eliot B. Moss, “Transactional Memory, Architectural Support for Lock-Free Data Structures”, ACM Special Interest Group on Computer Architecture, pp. 289-300, 1993. It is highly possible that there is a need for switching during the execution of a transaction; that is, a transaction which is being executed has to be switched out and then switched in at an appropriate time. The reasons for implementing switching include that a transaction can be interrupted by a timer by an exception, e.g., Translation Lookaside Buffer (TLB) miss.

Generally, a hardware-based transaction footprint recorder is adopted in the implementation of TM, to record the footprints of a transaction which include for example memory addresses from which the transaction reads data, memory addresses to which the transaction writes data, and data to be written.

For example, in Document 1, a cache in a processor core is used to record the footprints of a transaction. In other words, in Document 1, the hardware-based transaction footprint recorder is the cache in a processor core.

However, transaction switching is not supported in Document 1, since the cache's resource is limited, and moreover if a transaction is switched out, the footprints of the transaction may be stored in the cache for a long time, making the processor core unable to process the following transactions.

Recently, a solution has been proposed to support transaction switching in which costs are very high. For instance, the footprints of the switched-out transaction are stored to a software data structure stored in the memory, in Document 2, Ravi Rajwar, Maurice Herlihy and Konrad Lai, “Virtualizing Transactional Memory”, Proceedings of the 32nd Annual International Symposium on Computer Architecture, pp. 494-505, 2005. The drawbacks of Document 2 include that the conflict detection is relatively complicated and costs are high. The reason is that even if a transaction is switched out, it is still necessary to access the footprints of the switched-out transaction in order to perform the conflict detection, i.e., whether there is conflict between the switched-out transaction and a transaction being active currently. Thus, it is necessary to check the cache recording footprints of the active transaction and the memory storing the footprints of the switched-out transaction, while the access of memory takes a long time.

Therefore, a method and apparatus for implementing TM are in needed to overcome the above drawbacks.

### SUMMARY OF THE INVENTION

According to one aspect of the present invention, a method for implementing transaction memory (TM) is provided, which includes the steps of allocating a hardware-based transaction footprint recorder to the transaction, for recording footprints of the transaction when a transaction is begun; determining that the transaction is to be switched out; and switching out the transaction, where the footprints of the switched-out transaction are still kept in the hardware-based transaction footprint recorder.

According to another aspect of the present invention, an apparatus for implementing transaction memory (TM) is proposed, which includes means for allocating a hardware-based transaction footprint recorder to the transaction for recording footprints of the transaction when a transaction is begun; means for determining that the transaction is to be switched out; and means for switching out the transaction, where the footprints of the switched-out transaction are still kept in the hardware-based transaction footprint recorder.

Additionally, according to an aspect of the present invention, a computer readable article of manufacture tangibly embodying computer readable instructions for executing a computer implemented method for implementing transaction memory is provided. The method includes the steps of: allocating a hardware-based transaction footprint recorder to a transaction, for recording footprints of the transaction when the transaction is begun; determining that the transaction is to be switched out; and switching out the transaction, where the footprints of the switched-out transaction are kept in the hardware-based transaction footprint recorder.

By using the present invention, not only transaction switching is supported by TM, but also the cost of conflict detection between an active transaction and a switched-out transaction is greatly reduced, because the footprints of the switched-out transaction are still kept in the hardware-based transaction footprint recorder.

### BRIEF DESCRIPTION ON THE DRAWINGS

Other objects and effects of the present invention will become more apparent and easy to understand from the following description, taken in conjunction with the accompanying drawings:

FIG. 1 schematically shows a system 100 in which the present invention can be implemented;

FIG. 2 shows how footprints of a transaction are recorded in a buffer according to an embodiment of the present invention;

FIG. 3 shows a case where a color bit for identifying to which transaction the footprints belong is incorporated in each entry of the footprints of a transaction, according to an embodiment of the present invention; and

FIG. 4 shows a flow chart of the method for implementing TM according to an embodiment of the present invention.

Like reference numerals designate the same, similar, or corresponding features or functions throughout the drawings.

### DETAILED DESCRIPTION OF THE PREFERRED EMBODIMENTS

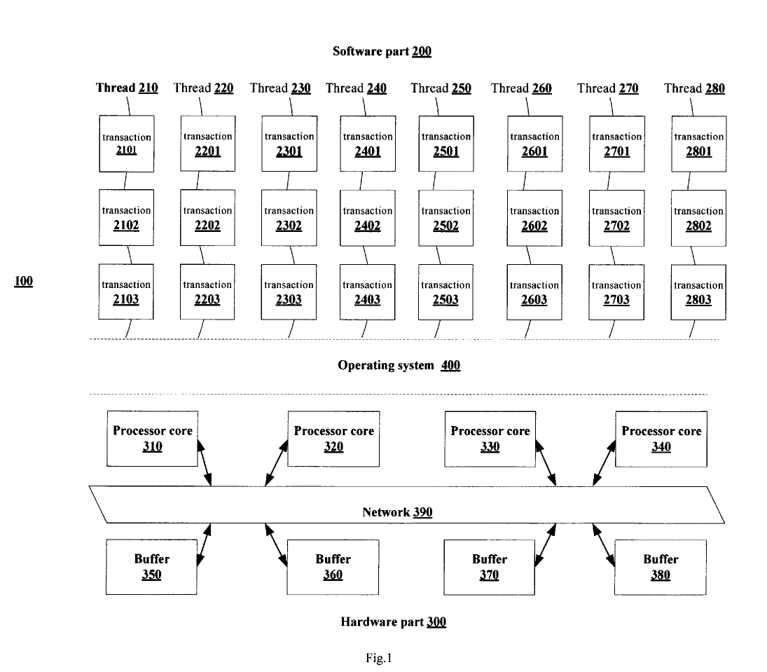

FIG. 1 schematically shows a system 100 in which the present invention can be implemented.

As shown in FIG. 1, the system 100 includes a software part 200, a hardware part 300 and an operating system 400 for controlling and managing the software part 200 and hardware part 300.

In an embodiment of the present invention, the method and apparatus of the present invention are implemented by the operating system 400.

Of course, those skilled in the art will understand that the method and apparatus of the present invention can also be implemented by hardware, firmware, middleware software, or even application layer software.

The hardware part 300 includes processor cores 310, 320, 330 and 340, buffers 350, 360, 370 and 380, and a network 390 connecting the processor cores 310, 320, 330 and 340 and the buffers 350, 360, 370 and 380.

Namely, in the hardware part 300 as shown in FIG. 1, buffers 350, 360, 370 and 380 are shared by processor cores 310, 320, 330 and 340, processor cores 310, 320, 330 and 340 can access anyone of the buffers 350, 360, 370 and 380.

Certainly, those skilled in the art will understand that the buffers 350, 360, 370 and 380 may connect to the processor cores 310, 320, 330 and 340 via a bus. Even direct links can be used to connect the buffers 350, 360, 370 and 380 with the processor cores 310, 320, 330 and 340.

Indeed, those skilled in the art will understand that the numbers of buffers and processor cores are not limited to four; other numbers are also possible.

In another embodiment of the present invention, the relationships between buffers and processor cores are fixed. As an example, the buffer 350 is fixed to be used by the processor cores 310 and 320 only, the buffer 360 is fixed to be used by the processor cores 320 and 330 only, the buffer 370 is fixed to be used by the processor cores 330 and 340 only, and the buffer 380 is fixed to be used by the processor cores 310 and 340 only.

The software part 200 includes threads 210, 220, 230, 240, 250, 260, 270 and 280. Each of these threads includes multiple transactions. Thread 210 includes transactions 2101, 2102 and 2103, thread 220 includes transactions 2201, 2202 and 2203, thread 230 includes transactions 2301, 2302 and 2303, thread 240 includes transactions 2401, 2402 and 2403, thread 250 includes transactions 2501, 2502 and 2503, thread 260 includes transactions 2601, 2602 and 2603, thread 270 includes transactions 2701, 2702 and 2703, and thread 280 includes transactions 2801, 2802 and 2803. The threads 210, 220, 230, 240, 250, 260, 270 and 280 can belong to a same process or different processes.

In the system 100, the threads 210, 220, 230, 240, 250, 260, 270 and 280 are executed concurrently, but multiple transactions in each thread are executed in series.

Of course, those skilled in the art will understand that the number of threads is not limited to eight; other numbers are also possible. Moreover, the number of transactions in each thread is not strictly limited to three; other numbers are also possible.

In an embodiment of the present invention, the buffers 350, 360, 370 and 380 are used as footprint recorders for each transaction in the threads 210, 220, 230, 240, 250, 260, 270 and 280, for recording the footprints of each transaction.

The footprints of each transaction include memory addresses from which a transaction reads data, memory addresses to which a transaction writes data, and data to be written.

It is noted that, the time for accessing the buffers by the processor cores will be less than the time for accessing the shared memory (not shown in FIG. 1) by the processor cores.

In one embodiment of the present invention, the processor cores 310, 320, 330 and 340 and the buffers 350, 360, 370 and 380 are located on a same chip, but the memory is not on that chip. Furthermore, the above-mentioned buffers can be dedicated buffers, i.e., caches of each processor core.

In an embodiment of the present invention, at the beginning of a transaction of a thread, for example, when the transaction 2101 of the thread 210 is begun, the operating system 400 allocates to the transaction 2101 a buffer, for instance, the buffer 350.

Those skilled in the art will understand that, the operating system 400 is able to have information on the usage states of buffers 350, 360, 370 and 380, and thus, when a transaction is begun, the operating system 400 can allocate a buffer which has not been used by other transaction to the beginning transaction.

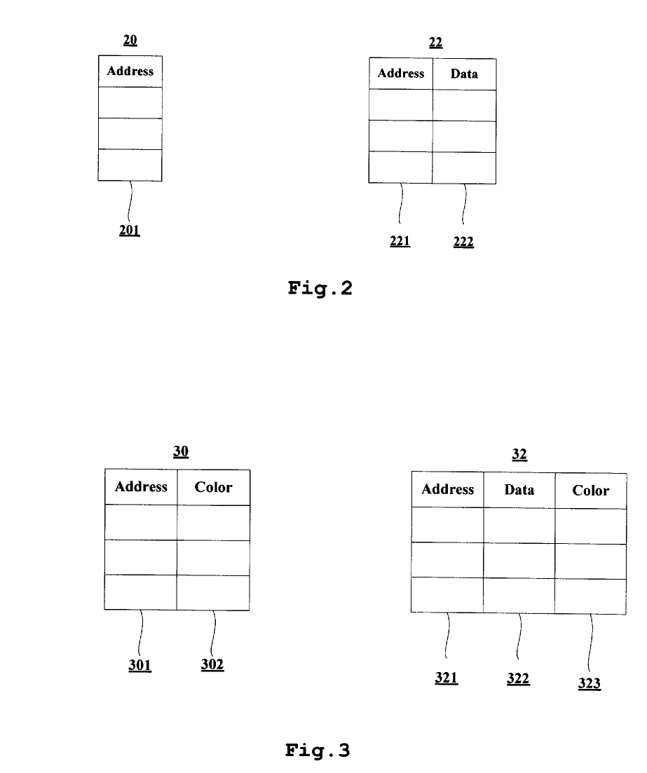

FIG. 2 shows how footprints of a transaction are recorded in a buffer, for instance, in the buffer 350, according to an embodiment of the present invention. As shown in FIG. 2, there are two tables 20 and 22 in the buffer 350. The table 20 only includes one column 201 for recording memory addresses from which a transaction reads data, while table 22 has two columns 221 and 222, where column 221 is for recording memory addresses to which a transaction writes data, and the other column 222 is for recording data to be written. That is to say, each entry (each line) in table 20 represents a memory address from which a transaction reads data, and each entry (each line) in table 22 represents a memory address to which a transaction writes data and data to be written.

In one embodiment of the present invention, the threads 210, 220, 230, 240, 250, 260, 270 and 280 are bound to one or more buffers of the buffers 350, 360, 370 and 380. For instance, the threads 210, 220 and 230 are bound to the buffer 350, the threads 230 and 240 are bound to the buffer 360, the threads 250 and 260 are bound to the buffer 370, and the threads 270 and 280 are bound to the buffer 380. More specifically, in the embodiment, footprints of transactions of the threads 210 and 220 can only be recorded in the buffer 350, footprints of transactions of the thread 240 can only be recorded in the buffer 360, footprints of transactions of the thread 230 can only be recorded in the buffers 350 and 360, footprints of transactions of the threads 250 and 260 can only be recorded in the buffer 370, and footprints of transactions of the threads 270 and 280 can only be recorded in the buffer 380.

In other words, in the embodiment, in the case that footprints of transactions of the thread 210 have been recorded in the buffer 350, even if the buffers 360, 370 and/or 380 are empty, they cannot be used to record the footprints of transactions of the thread 220, thus making the threads 220 and 210 unable to be executed concurrently.

In one embodiment of the present invention, one or more buffers of the buffers 350, 360, 370 and 380 can be allocated to multiple transactions simultaneously by adding a “color bit” for identifying which transaction (i.e., which thread, since each transaction of one thread being executed in series) the footprints belong to each entry of the tables as shown in FIG. 2. As an example, if the color bit occupies two bits, the two bits can be used to indicate that one corresponding buffer can be allocated to four transactions simultaneously.

FIG. 3 shows a case where a color bit for identifying the transaction to which the footprints belong is incorporated in each entry of the footprints of a transaction, according to an embodiment of the present invention.

As shown in FIG. 3, there are two tables 30 and 32 in the buffer 350. The table 30 has two columns 301 and 302, where column 301 is for recording memory addresses from which a transaction reads data, while column 302 is for recording color bit for identifying to which transactions the information in column 301 belongs. The table 32 includes three columns 321, 322 and 323, where column 321 is for recording memory addresses to which a transaction writes data, column 322 is for recording data to be written, and column 323 is for recording color bit for identifying to which transactions the information in columns 321 and 322 belong.

The operating system 400 can determine, through a color register, whether a buffer can be allocated to the transaction. As an example, an initial value of the color register can be set to a maximum value of the number of transactions which can be allocated to one buffer, and the value in the color register is decreased by one when one transaction is allocated to the buffer. When one transaction does not require the buffer to record its footprints, the footprints of the transaction are deleted from the buffer, and the value in the color register is increased by one. When the value in the color register is zero, this means that no transaction can be allocated to the buffer.

Additionally, the color register also records corresponding relationships between colors and transactions. That is, once a color is applied to one transaction, the corresponding relationships are updated dynamically. The color register can be in a corresponding buffer.

In another embodiment of the present invention, all transactions of the same thread are allocated to the same buffer. That is, in the embodiment, the allocation of buffers is implemented with a thread as the granularity. For instance, if the first transaction 2101 of the thread 210 is allocated to the buffer 350, the second transaction 2102 and the third transaction 2103 of the thread 210 are allocated to the buffer 350 as well.

In an embodiment of the present invention, when the operating system 400 determines one transaction has to be switched out for a reason, the footprints of the transaction are still kept in the buffer which is allocated to the transaction at the beginning, instead of removing the footprints of the switched-out transaction from the cache to, for example, a memory in the original location. The reasons for implementing switching include that the transaction might be interrupted by a timer, be interrupted by a exception, e.g., Translation Lookaside Buffer (TLB) miss.

The advantages of this solution include that the cost of conflict detection between an active transaction and a switched-out transaction is greatly reduced, because it is unnecessary to access the memory for accessing the footprints of the switched-out transaction to implement the conflict detection, with both the footprints of the active transaction and footprints of the switched-out transaction maintained in the buffer. Actually, it will take a longer time to access the memory than to access the buffer.

The conflict detection can be implemented by a conflict arbiter. The present invention is not concerned with how the conflict arbiter implements the conflict detection, that is, what standard is used to decide that there is a conflict between an active transaction and a switched-out transaction is not of concern. The conflict detection result can be to abort the active transaction or to abort the switched-out transaction. The conflict arbiter is not shown in FIG. 1; it can be a part of the operating system 400, hardware, firmware, middleware software, or even application layer software. If it is not a part of the operating system 400, it may communicate the conflict detection result to the operating system 400. For example, the conflict arbiter can write an identifier of a transaction to be aborted since there is a conflict in a data structure (aborted buffer) which is in a memory and can be accessed by the operating system, application programs, etc.

When an event leading to the switching out of a transaction terminates and it is needed to switch in the switched-out transaction, the operating system 400 switches in the transaction. Then, the operating system 400 determines whether the transaction that is switched out and then switched in is aborted by examining the above-mentioned aborted buffer. In the case for which the switched-out transaction does not need to be aborted, the operating system 400 continues executing the transaction.

In an embodiment of the present invention, the footprints of the switched-in transaction are still recorded in the buffer allocated to the transaction before switched-out. In the case that the switched-out transaction needs to be aborted, the operating system 400 aborts the transaction. When a transaction is aborted, its footprints in the buffer are deleted. Then, the operating system 400 re-executes the aborted transaction. When re-executing the aborted transaction, it is not necessary to allocate it to the buffer allocated to it before it is aborted, any buffer can be allocated to the re-executed transaction.

In an embodiment of the present invention, the switched-in transaction can be executed on a processor core different from the one on which it was executed before being switched-out. For instance, if the transaction 2101 is executed on processor core 310 before it is switched-out, then the transaction 2101 may be executed on processor core 320 after it is switched in.

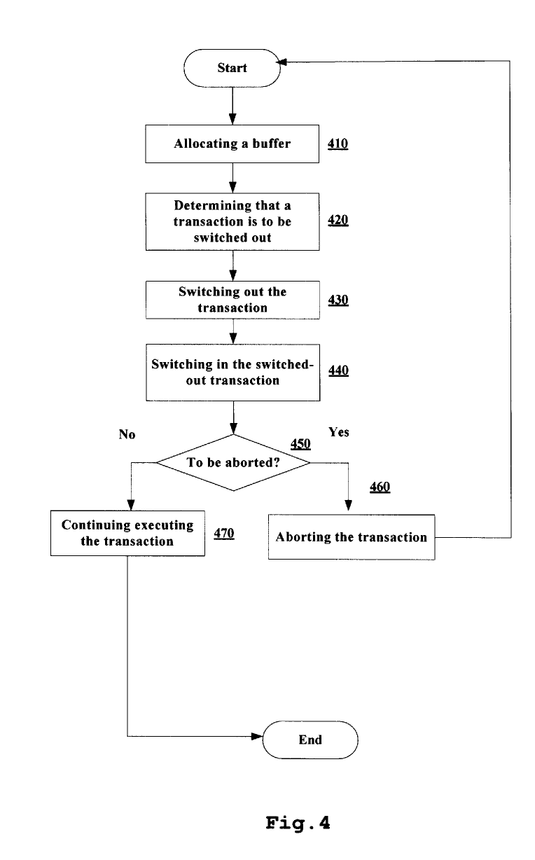

FIG. 4 shows a flow chart of the method for implementing TM according to an embodiment of the present invention. The method is implemented by the operating system 400, for example.

First, when a transaction is begun, a hardware-based transaction footprint recorder (for example, the buffer 350) is allocated to the transaction, for recording the footprints of the transaction (step S410).

Next, it is determined that the transaction must be switched out for one or more reasons (step S420).

Then, the transaction is switched out (step S430).

The footprints of the transaction include memory addresses from which the transaction reads data, memory addresses to which the transaction writes data, and data to be written. The footprints of the switched-out transaction are still kept in the hardware-based transaction footprint recorder, instead of being moved, for instance, to memory.

In an embodiment of the present invention, the hardware-based transaction footprint recorder is shared by multiple processor cores.

In an embodiment of the present invention, the hardware-based transaction footprint recorder can be allocated to multiple transactions simultaneously by incorporating a color bit for identifying to which transaction the footprints belong in each entry of the footprints of a transaction. Thus, before step S410, the method further includes the step of accessing a color register to determine whether the hardware-based transaction footprint recorder can be allocated to the transaction (the step is not shown in FIG. 4).

In an embodiment of the present invention, the hardware-based transaction footprint recorder is one of multiple hardware-based transaction footprint recorders. Next, in step S440 the switched-out transaction is switched in. Then, in step S450, it is determined whether the transaction which is switched out and then switched in must be aborted since there is a conflict between it and an active transaction.

If the answer in step S450 is no, the process proceeds to step S470. In step S470, the switched-in transaction continues to be executed, where the footprints of the switched-in transaction are recorded in the buffer allocated before the transaction is switched out. If the answer in step S450 is yes, the process proceeds to step S460.

In step S460, the transaction to be aborted is aborted. Then, the process returns to step S410 to re-execute the aborted transaction.

In an embodiment of the present invention, all other transactions belonging to the same thread as that to which the transaction belongs are allocated to the hardware-based transaction footprint recorder. Those skilled in the art will understand that, during the process of continuing the execution of the transaction which is switched out and then switched in, the transaction can be switched out again.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A method for implementing transaction memory, comprising the steps of:
allocating a hardware-based transaction footprint recorder to a transaction, for recording footprints of said transaction when the transaction is begun;
determining that said transaction is to be switched out; and
switching out said transaction;
wherein the footprints of said switched-out transaction are kept in said hardware-based transaction footprint recorder.

2. The method according to claim 1, wherein said hardware-based transaction footprint recorder is shared by multiple processor cores.

3. The method according to claim 1, wherein said hardware-based transaction footprint recorder is allocated to multiple transactions simultaneously by incorporating a color bit for identifying to which transaction the footprints belong in each entry of footprints of a transaction.

4. The method according to claim 1, wherein said method further comprises the step of:
accessing a color register to determine whether said hardware-based transaction footprint recorder can be allocated to said transaction.

5. The method according to claim 1, further comprising the step of:
switching in said switched-out transaction.

6. The method according to claim 1, further comprising the step of:
aborting said switched-out transaction.

7. The method according to claim 1, wherein all other transactions belonging to the same thread as that to which said transaction belongs are allocated to said hardware-based transaction footprint recorder.

8. The method according to claim 1, wherein said hardware-based transaction footprint recorder is a dedicated buffer or a cache associated with one of multiple processor cores.

9. The method according to claim 1, wherein the footprints of said transaction comprise:
memory addresses from which said transaction reads data;
memory addresses to which said transaction writes data; and
data to be written.

10. An apparatus for implementing transaction memory, wherein said apparatus comprises:
means for allocating a hardware-based transaction footprint recorder to a transaction for recording footprints of said transaction when the transaction is begun;
means for determining that said transaction is to be switched out; and
means for switching out said transaction;
wherein the footprints of said switched-out transaction are kept in said hardware-based transaction footprint recorder.

11. The apparatus according to claim 10, wherein said hardware-based transaction footprint recorder is shared by multiple processor cores.

12. The apparatus according to claim 10, wherein said hardware-based transaction footprint recorder is allocated to multiple transactions simultaneously by incorporating a color bit for identifying to which transaction the footprints belong in each entry of footprints of a transaction.

13. The apparatus according to claim 10, wherein said apparatus further comprises:
means for accessing a color register to determine whether said hardware-based transaction footprint recorder can be allocated to said transaction.

14. The apparatus according to claim 10, further comprising:
means for switching in said switched-out transaction.

15. The apparatus according to claim 10, further comprising:
means for aborting said switched-out transaction.

16. The apparatus according to claim 10, wherein all other transactions belonging to the same thread as that to which said transaction belongs are allocated to said hardware-based transaction footprint recorder.

17. The apparatus according to claim 10, wherein said hardware-based transaction footprint recorder is a dedicated buffer or a cache associated with one of multiple processor cores.

18. The apparatus according to claim 10, wherein the footprints of said transaction comprise:
memory addresses from which said transaction reads data;
memory addresses to which said transaction writes data; and
data to be written.

19. A computer readable article of manufacture tangibly embodying computer readable instructions for executing a computer implemented method for implementing transaction memory, the method comprising the steps of:
allocating a hardware-based transaction footprint recorder to a transaction for recording footprints of said transaction when the transaction is begun;
determining that said transaction is to be switched out; and
switching out said transaction;
wherein the footprints of said switched-out transaction are kept in said hardware-based transaction footprint recorder.

20. A computer readable article of manufacture according to claim 19, wherein said hardware-based transaction footprint recorder is allocated to multiple transactions simultaneously by incorporating a color bit for identifying to which transaction the footprints belong in each entry of footprints of a transaction.
